(19) United States
(12) Patent Application Publication
(10) Pub. No.: US 2009/0025454 A1
(43) Pub. Date: Jan. 29, 2009

(54) SYSTEM AND METHOD FOR DETECTING LEAKS IN SEALED COMPARTMENTS

(76) Inventors: Scott Farrell, Brentwood, TN (US); Howard C. Samson, Murfreesboro, TN (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/129,412

(22) Filed: May 29, 2008

Related U.S. Application Data
(63) Continuation-in-part of application No. 11/586,418, filed on Oct. 25, 2006.
(60) Provisional application No. 60/834,019, filed on Jul. 28, 2006.
(60) Provisional application No. 60/730,227, filed on Oct. 25, 2005.
(60) Provisional application No. 60/940,579, filed on May 29, 2007.

(51) Int. Cl. G01M 3/24

(52) U.S. Cl. 73/40.5 A

(57) ABSTRACT

The present disclosure generally pertains to systems and methods for reliably detecting leaks in sealed compartments, such as compartments within vehicles. In one exemplary embodiment, an apparatus having a sealed compartment, such as a vehicle (e.g., automobile, airplane, etc.), is moved past an array of ultrasonic sensors. An ultrasonic transmitter is placed in the sealed compartment and emits ultrasonic energy as the apparatus is moved past the ultrasonic sensors. The transmitter has a plurality of adjustable transducers allowing the transmit profile of the transmitter to be tailored as may be desired, such as based on the type of compartment being tested. A leak can be automatically and non-destructively detected by analyzing data from the ultrasonic sensors.

### CROSS REFERENCE TO RELATED APPLICATIONS

This application is a continuation-in-part of U.S. application Ser. No. 11/586,418, entitled “System and Method for Controlling Emission of Acoustic Energy for Detecting Leaks in Vehicles,” and filed on Oct. 25, 2006, which is incorporated herein by reference. U.S. application Ser. No. 11/586,418 claims priority to U.S. Provisional Patent Application No. 60/834,019 and U.S. Provisional Patent Application No. 60/730,227, which are both incorporated herein by reference. This application claims priority to U.S. Provisional Patent Application No. 60/940,579, entitled “System and Method for Detecting Leaks is Sealed Compartments,” and filed on May 29, 2007, which is incorporated herein by reference.

### RELATED ART

In the manufacture or repair of products that include a sealed compartment, various methods have been used to determine how well the compartment is sealed, and where water or air intrusion (or extrusion) might occur. In the case of vehicles, for example, it is important to verify that water will not leak into the passenger compartment. Since visual inspection can be highly unreliable, certain vehicle manufacturers utilize spray booths for subjecting fully assembled vehicles to an intense water spray to ensure that vehicles shipped from the factory will not leak due to faulty or damaged seals. While this type of testing can be fairly reliable, it requires a worker to check for the presence of water in the cabin, and it is destructive in the sense that it can cause significant water intrusion in poorly sealed vehicles, or in vehicles where a window or door has been inadvertently left partially open, requiring significant expenditure of time and material for repairs due to water damage. Additionally, the spray booths are expensive to install and maintain, and cannot be easily duplicated at vehicle service and repair facilities.

In attempts to alleviate some of the problems associated with spray booths, some leak detection systems employ ultrasonic sensors to non-destructively detect leaks within vehicles. U.S. Pat. No. 6,983,642 entitled “System and Method for Automatically Judging the Sealing Effectiveness of a Sealed Compartment,” which is incorporated herein by reference, describes one such leak detection system. In this regard, at least one ultrasonic transmitter is placed within the passenger compartment of a vehicle and emits ultrasonic energy. Ultrasonic sensors on the outside of the vehicle are used to determine the levels of ultrasonic energy within a close proximity of the vehicle. Ultrasonic energy may escape from the vehicle through a leak causing an increased amount of ultrasonic energy external to the vehicle at or close to the location of the leak. Thus, by detecting the increased ultrasonic energy, a sensor can detect the presence of the leak.

Unfortunately, manufacturing an efficient and reliable leak detection system that utilizes non-destructive ultrasonic sensing capabilities can be difficult and expensive. Further, it is contemplated that a convenient location for a leak detection system is on or close to an assembly line of a vehicle manufacturer. Such an environment can be extremely noisy and, therefore, adversely affect the performance of the leak detection system. Moreover, better and less expensive leak detection systems and methods capable of non-destructively detecting leaks of sealed compartments, such as passenger compartments of vehicles, are generally desirable.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary leak detection system in accordance with the present disclosure.

FIG. 2 depicts a side view of an exemplary vehicle tested by the leak detection system of FIG. 1.

FIG. 3 depicts a section top view of the vehicle of FIG. 2 tested by the leak detection system of FIG. 1.

FIG. 4 depicts a section rear view of the vehicle of FIG. 2 tested by the leak detection system of FIG. 1.

FIG. 5 depicts a section front view of the vehicle of FIG. 2 tested by the leak detection system of FIG. 1.

FIG. 6 depicts a top view of an exemplary transmitter emission profile for an ultrasonic transmitter of the leak detection system depicted in FIG. 1.

FIG. 7 depicts a rear view of the exemplary transmitter emission profile depicted in FIG. 6.

FIG. 8 depicts a side view of the exemplary transmitter emission profile depicted in FIG. 6.

FIG. 9 depicts exemplary ultrasonic emission from a transducer, such as may be used by a transmitter for the leak detection system depicted in FIG. 1.

FIG. 10 depicts a two-dimensional view of exemplary ultrasonic energy emission from a transducer, such as may be used by a transmitter of the leak detection system depicted in FIG. 1.

FIG. 11 depicts a two-dimensional view of exemplary ultrasonic energy emission from two transducers, such as may be used by a transmitter of the leak detection system depicted in FIG. 1.

FIG. 12 depicts an exemplary transmitter for the leak detection system depicted in FIG. 1.

FIG. 13 is a top view of the transmitter of FIG. 12.

FIG. 14 is a side view of the transmitter of FIG. 12.

FIG. 15 is a bottom view of the transmitter of FIG. 12.

FIG. 16 depicts an exemplary placement of the transmitter of FIG. 12 within the interior the vehicle depicted in FIG. 4.

FIG. 17 depicts an exemplary emission profile measurement system for creating a polar plot of horizontal emissions from a transmitter, such as is depicted by FIG. 12.

FIG. 18 is an exemplary polar plot of horizontal emission for the exemplary transmitter of FIG. 12.

FIG. 19 depicts an exemplary emission profile measurement system for creating a polar plot of vertical emissions from a transmitter, such as is depicted by FIG. 12.

FIG. 20 is an exemplary polar plot of vertical emission for the exemplary transmitter of FIG. 12.

FIG. 21 depicts a transducer coupled to an adjustable drive circuit for the leak detection system of FIG. 1.

FIG. 22 depicts a transducer coupled to a programmable drive circuit for the leak detection system of FIG. 1.

FIG. 23 depicts an exemplary array of adjustable drive circuits and transducers for the leak detection system of FIG. 1.

FIG. 24 depicts an exemplary array of programmable drive circuits and transducers for the leak detection system of FIG. 1.

FIG. 25 depicts a flow chart that illustrates an exemplary methodology for using adjustable drive circuits to provide a transmitter profile for a transmitter.

FIG. 26 depicts a flow chart that illustrates an exemplary methodology for using programmable drive circuits to provide a transmitter profile for a transmitter.

### DETAILED DESCRIPTION

The present disclosure generally pertains to systems and methods for reliably detecting leaks in sealed compartments, such as compartments within vehicles. In several embodiments of the present disclosure, an apparatus having a sealed compartment, such as a vehicle (e.g., automobile, airplane, etc.), is moved past an array of ultrasonic sensors. An ultrasonic transmitter is placed in the sealed compartment and emits ultrasonic energy as the apparatus is moved past the ultrasonic sensors. A leak can be automatically and non-destructively detected by analyzing data from the ultrasonic sensors.

For purposes of illustration, the systems and methods of the present disclosure will be described hereafter as detecting leaks within sealed compartments, such as passenger compartments or trunks, of vehicles (e.g., automobiles, aircraft, boats, etc.). It is to be understood, however, that the systems and methods of the present disclosure may be similarly used to detect leaks in other types of sealed compartments.

Note that the systems and methods of the present disclosure may be used to test compartments having either hermetic or non-hermetic seals. For example, a passenger compartment of an automobile is typically non-hermetic in that there typically exists at least some normal leakage in the passenger compartment even if the compartment and, in particular, the seals of the compartment are non-defective. In such embodiments, systems in accordance with the present disclosure can be configured to detect only leaks that are abnormal in the sense that they allow an excessive or greater than an expected or desired amount of leakage thereby making the compartment seal defective. For example, a leak in a vehicle that allows an unacceptable amount of water or air intrusion is abnormal, whereas any leak in a compartment designed in another example to be hermetically sealed is abnormal.

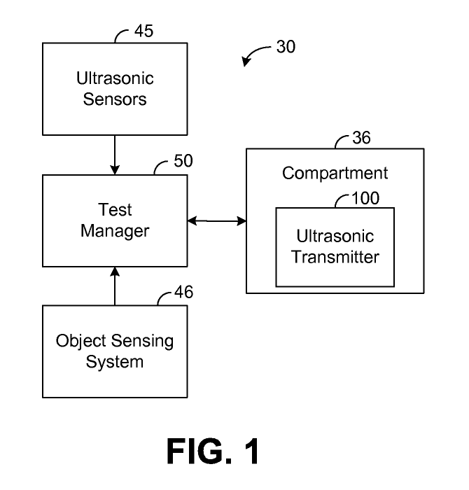

FIG. 1 depicts a leak detection system 30 that tests for abnormal compartment leaks in accordance with an exemplary embodiment of the present disclosure. An exemplary leak detection system for detecting abnormal leaks is described in U.S. Utility patent application Ser. No. 11/586,418 entitled, “System and Method for Controlling Emission of Acoustic Energy for Detecting Leaks in Vehicles” filed on Oct. 25, 2006 which is incorporated herein by reference. The system 30 comprises an ultrasonic transmitter 100 that is placed within a compartment 36, such as a passenger compartment of a vehicle (not specifically shown in FIG. 1). The compartment 36 is moved past ultrasonic sensors 45 tuned to the one or more frequencies of the transmitter 100. In one exemplary embodiment, the transmitter 100 emits ultrasonic energy at one or more frequencies of approximately 40 kilo-Hertz (kHz). An object sensing system 46 detects a location of the vehicle during the test, and ultrasonic sensors 45 detect ultrasonic energy that escapes from the compartment 36 as it is moved past the sensors 45. Based on the ultrasonic energy detected by the sensors 45, a test manager 50 determines whether the compartment 36 has any abnormal leaks. Further, by analyzing the data from the sensors 45 relative to the position of the vehicle compartment 36 during the test (as determined from data provided by the object sensing system 46), the test manager 50 identifies a location of each abnormal leak detected by the system 30.

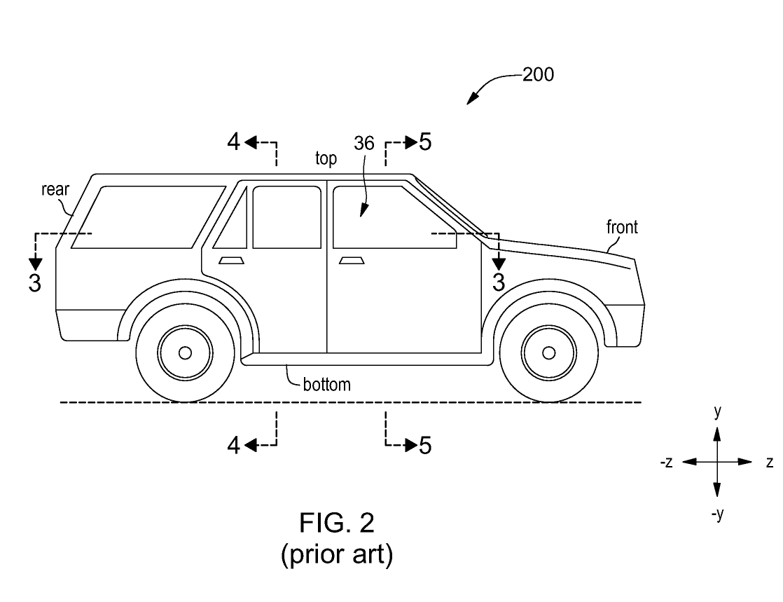

FIGS. 2-5 depict an exemplary vehicle 200 having a compartment 36, i.e., the interior of the vehicle. Within compartment 36 there are interior surfaces and interior components such as, front seats 22, back seats 24 and a console 38. The interior surfaces define the shape of compartment 36. In general, for different vehicles, there are variations in the sizes and shape of compartment 36.

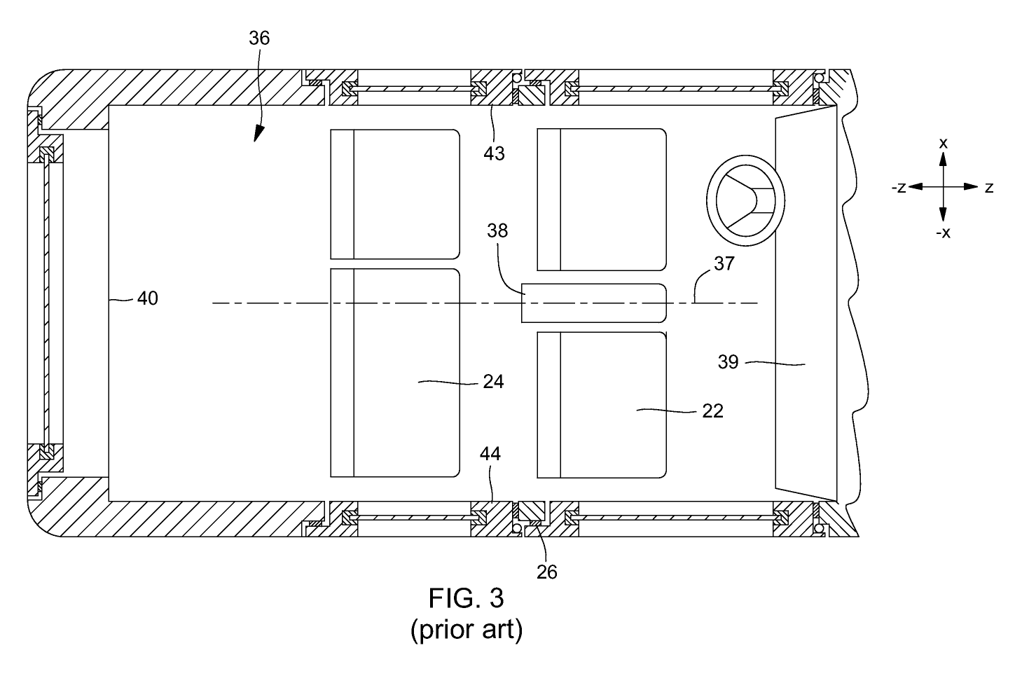

Interior surfaces that define compartment 36 of the vehicle 200 as shown in FIG. 2 are depicted in FIGS. 3-5. Such interior surfaces comprise a front surface 39, a left side surface 43, a right side surface 44, a top surface 41, a rear surface 40 and a bottom surface 42. Abnormal leaks may occur in several areas on or between such interior surfaces. For example, on front surface 39, abnormal leaks may be prone between the front window (not specifically shown) and the frame of vehicle 100. For side surface 43 or 44, abnormal leaks may be prone between the passenger doors and the vehicle frame. There may be other areas where abnormal leaks are prone.

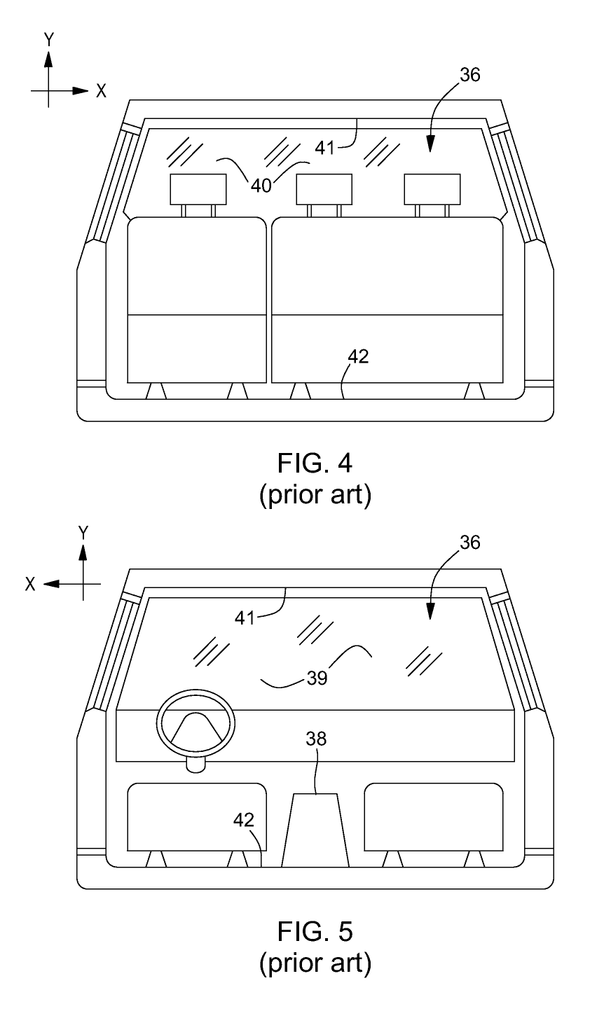

The length of compartment 36 is measured in the z direction, the width in the x direction (FIG. 3) and the height in the y direction (FIG. 4). A longitudinal axis 37 of compartment 36 is defined as a line that is parallel to the z direction and centered between side surfaces 43, 44 of compartment 36. In one embodiment, transmitter 100 is aligned with the longitudinal axis of compartment 36 and placed on a console 38 within compartment 36. In other embodiments, transmitter 100 is placed at other locations, such as, for example, on one of the seats 22, 24 within compartment 36.

A section view of the vehicle 200, as depicted in FIG. 3, illustrates an exemplary door seal 26 used for eliminating or reducing leakage between the door and the body of the vehicle. At side surface 43, an abnormal leak may occur between the door and the edges of the door-frame opening, for example, when the door seal 26 has a defect. In addition, abnormal leaks may occur in other areas of compartment 36, such as, for example, around a seal of a door window.

FIG. 4 depicts a section rear view of the vehicle 200 as seen when looking in the negative z direction (towards the back of vehicle 200). When transmitter 100 is placed in compartment 36, a portion of the emitted energy from transmitter 100 is directed towards (the negative z direction) the rear surface 40 of compartment 36. Such directed energy is provided for detecting abnormal leaks at or near areas of rear surface 40.

FIG. 5 depicts a section front view of vehicle 200 as seen when looking in the z direction. When transmitter 100 is placed within compartment 36, a portion of the emitted energy from the transmitter 100 is directed towards (the z direction) front surface 39 of compartment 36. Such emitted energy is provided for detecting abnormal leaks at or near areas of the front surface 39.

Another area where a leak could occur is in top surface 41 (the ceiling of vehicle 200) of compartment 36. In general, leaks in the top surface 41 are unlikely unless the vehicle 200 has a sunroof. Leaks may also occur in bottom surface 42 of compartment 36 (the vehicle floor). However, abnormal leaks rarely occur through bottom surface 42.

The ultrasonic sensors 45 are configured to detect ultrasonic energy escaping from the compartment 36. If an abnormal amount of energy is sensed via one or more sensors 45, then the test manager 50 detects an abnormal leak and provides notification of such detection. Exemplary techniques for detecting and reporting abnormal leaks are described in U.S. Utility patent application Ser. No. 11/586,418 entitled, “System and Method for Controlling Emission of Acoustic Energy for Detecting Leaks in Vehicles” filed on Oct. 25, 2006 which is incorporated herein by reference. In one embodiment of leak detection system 30, the system is not configured to detect floor leaks since such leaks are relatively rare.

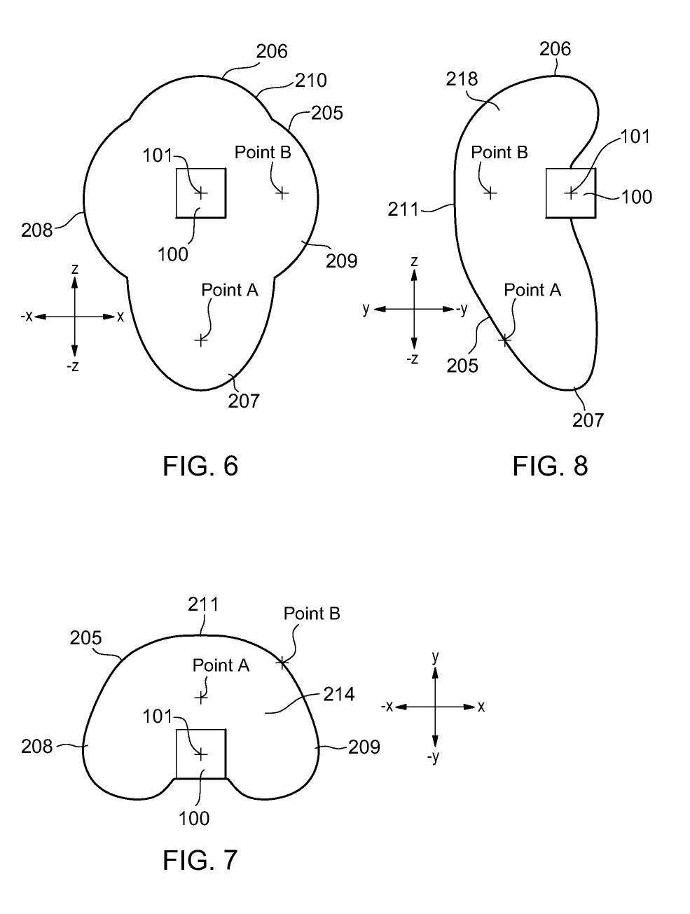

In one exemplary embodiment, the transmitter 100 has an ultrasonic energy emission profile (hereafter “profile”) 210 as depicted in FIGS. 6-8, although it is possible for transmitter 100 to have other profiles in other embodiments. Profile 210 is a three-dimensional shape where relative energy densities define a surface of the shape. Relative energy densities of profile 210 are measured at a fixed distance from transmitter 100. Such relative energy densities appear to be emitted from a center point 101 of transmitter 100. In a top view, as depicted in FIG. 6, the surface of profile 210 is represented by curved line 205. Curved line 205 represents energy density values with respect to a reference value and has units of decibels. A rear view (observed by looking in the z direction) of profile 210 is depicted in FIG. 7 where the shape of the profile 210 is again represented by the curved line 205. A side view (observed by looking in the minus x direction) of profile 210 is depicted in FIG. 8 where the shape of the profile is once more represented by the curved line 205.

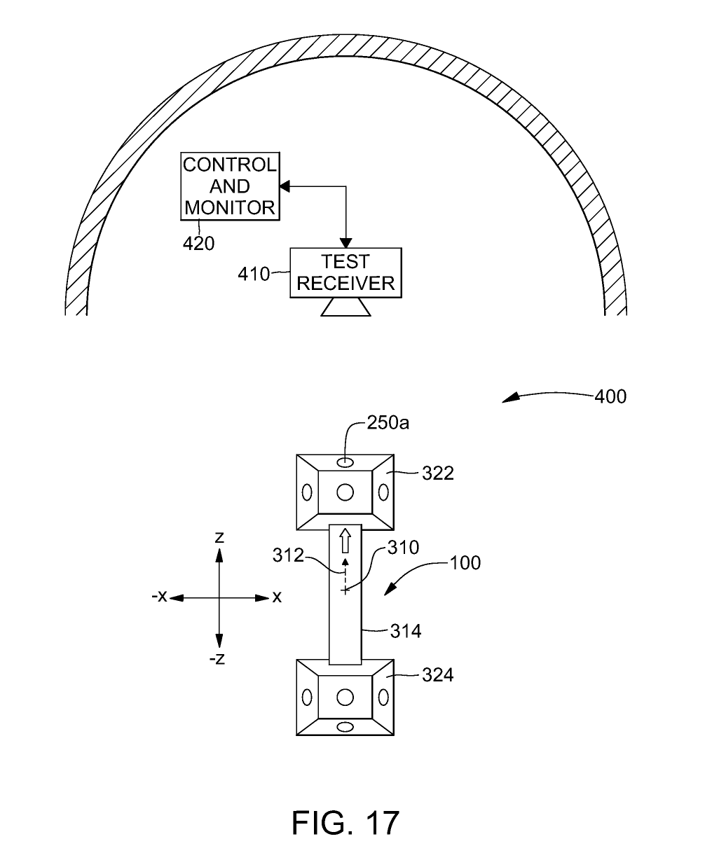

In order to assist in an understanding of profile 210 as depicted in FIGS. 6-8, examples of energy density points on the surface are provided. In a first example, Point A on the surface of profile 210 is located behind (the negative z direction) transmitter 100 as depicted in FIG. 6 and FIG. 8. Point A is shown to be above (the y direction) transmitter 100 as depicted in FIG. 7. The energy density for Point A in decibels is equal to the magnitude of a vector extending from center point 101 to Point A. In a second example, Point B on the surface of profile 210 is to the right (the x direction) of transmitter 100 as seen in FIG. 6 and FIG. 7. Point B is shown to be above (the y direction) transmitter 100 as seen in FIG. 8. The energy density for Point B in decibels is equal to the magnitude of a vector extending from center point 101 to Point B. Both Point A and Point B on the surface of profile 210 represent relative energy densities. In general, when a first point located on the surface of profile 210 is at a greater distance from transmitter 100 than a second point located on the surface of profile 210, then the energy density of the first point is greater than the energy density of the second point. In the examples, the energy density at Point A is greater than the energy density at Point B. Energy densities may be determined in a measurement chamber 400, such depicted in FIG. 17. Details of measurement techniques using the measurement chamber 400 are presented later.

Because the dimensions, including size and shape, of compartment 36 are determined by the manufacturer of the vehicle 200, profile 210 is modified for testing a variety of vehicles. Hence, profile 210 is adaptable for testing a variety of vehicles, such that the emission profile 210 of transmitter 100 may be uniquely tailored for the vehicle being tested. In that regard, U.S. patent application Ser. No. 11/586,418 describes exemplary techniques that may be used to associate different transmit profiles with different vehicles using a vehicle identifier, such as a VIN or a portion of a VIN, of the vehicle as a reference for selecting the appropriate transmission profile to be used during testing. Once profile 210 has a desired shape for reliably detecting abnormal leaks corresponding to a vehicle with a vehicle identifier, shape information is stored in memory and retrieved as needed.

In general, transmitter 100 emits energy towards interior surfaces of compartment 36 so that abnormal leaks are detected in areas of surfaces that are susceptible to leaks. In this regard, the transmitter 100 “coats” such areas of compartment 36 with ultrasonic energy. In many instances, it is desirable for transmitter 100 to coat vehicle interior surfaces with substantially equal amounts of ultrasonic energy. However, it is possible to coat vehicle interior surfaces with other amounts of ultrasonic energy.

In one exemplary embodiment, transmitter 100 is aligned, as will be further described, with longitudinal axis 37 of compartment 36. The exemplary profile 210 shown in FIGS. 6-8 has several lobes, including a front lobe 206. For such an alignment, front lobe 206 of profile 210 is positioned for emitting energy in the z direction, i.e., towards the front surface 39 of compartment 36. Hence front lobe 206 coats the front surface 39 with ultrasonic energy for detecting abnormal leaks around front surface 39 of compartment 36. When front lobe 206 is extending in the z direction, left side lobe 208 and right side lobe 209 are positioned for respectively coating side surfaces 43, 44 of compartment 36 with ultrasonic energy. Hence, the side lobes 208, 209 of profile 210 provide energy for detecting abnormal leaks around the side surfaces 43, 44. Further, when front lobe 206 is positioned for emitting energy in the z direction, rear lobe 207 is positioned for emitting energy towards (the negative z direction) the rear surface 40 of compartment 36 and detecting abnormal leaks in the rear surface 40. Similarly, top lobe 211 is positioned for coating the top surface 41 of compartment 36 with ultrasonic energy for detecting abnormal leaks in top surface 41.

In summary, profile 210 of transmitter 100 depicts energy emission values in three dimensions. Top view 210 as depicted in FIG. 6 shows energy emitted in the x directions and the z directions. Rear view 214 as depicted in FIG. 7, shows further details of side lobes 208, 209 and shows energy emitted in the y directions. The energy emitted downward (the minus y direction) has relatively small values for some embodiments of transmitter 100.

In profile 210 as depicted in FIG. 6, side lobes 208, 209 have values that are approximately equal. In general, when a profile has equal side lobes, such as side lobes 208, 209, the transmitter 100 has a best fit for equal energy coating of side surfaces, when the transmitter 100 is positioned at an equal distance from each of the side surfaces, such as side surfaces 43, 44. For embodiments where the transmitter 100 is positioned closer to the front surface 39 than to the back surface 40, the lobe providing energy for the back surface is preferably larger than the lobe furnishing energy to the front surface, such as lobes 207, 206 respectively.

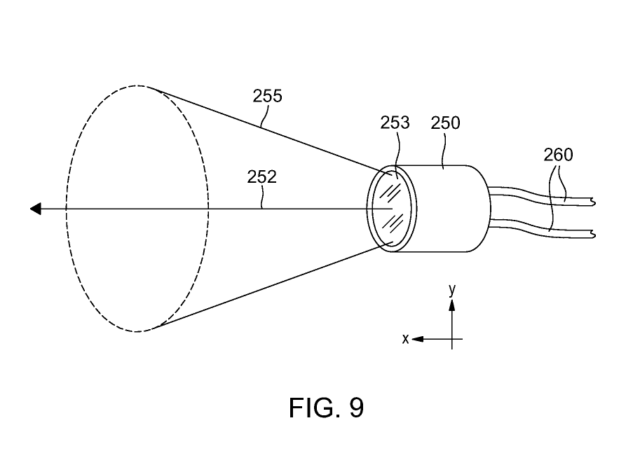

A conventional ultrasonic emission transducer 250, such as depicted in FIG. 9, alone is incapable of providing the exemplary profile 210 as shown in FIGS. 6-8. In general, the ultrasonic transducer 250 has an emission profile that is often described as having a conical-shaped boundary. When transducer 250 emits ultrasonic energy, the emission profile has an axis of emission 252 that is perpendicular to an emission surface 253 as depicted in FIG. 9. A reference energy density value, usually a maximum value, is measured along the axis of emission 252. A boundary 255, typically conical, is often defined by the half power emission value (a minus 3 dB value with respect to the maximum value) and is depicted as being radially symmetric about the axis of emission 252. In general, the energy density values measured just inside boundary 255 (towards the axis of emission 252) are slightly greater than the half-power value and the energy values measured just outside boundary 255 are slightly less than the half power value. It is understood by those skilled in the art that emission energy decreases with the inverse square of the distance from the emission source. A pair of wires 260 extending from the transducer 250 is coupled to a signal source (not shown) that supplies excitation energy to the transducer 250.

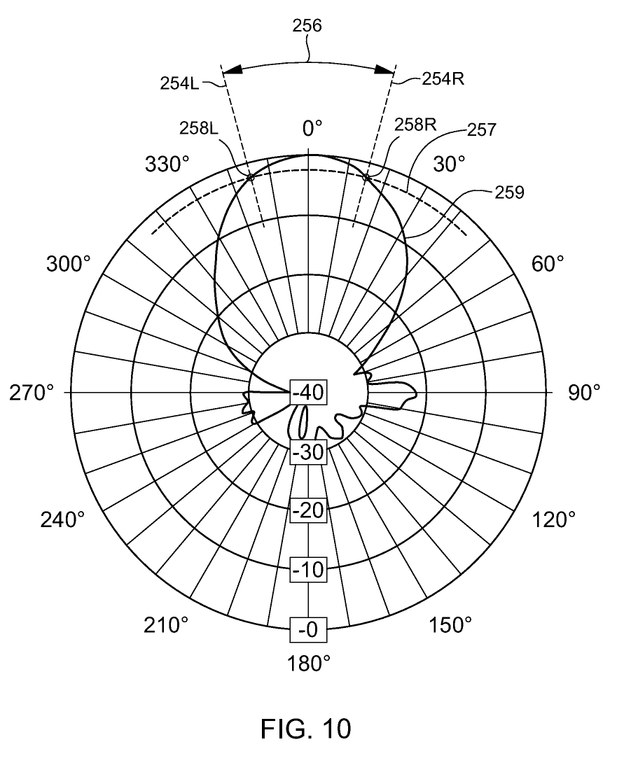

An emission profile of transducer 250 or other emitting device may be determined by taking measurements in a measurement chamber 400 such as shown in FIG. 17. However, a manufacturer often provides a data sheet showing an emission profile of a particular transducer. An exemplary emission characteristic for a transducer is depicted in FIG. 10 as a curved line 259 on a polar coordinate system. The manufacturer's transducer is a Mouser Electronics Model 255-400ST. Model 255-400ST has a conical shaped boundary defined by conical angle 256. Conical angle 256 is the angle between line 254L and 254R as shown in FIG. 10. Lines 254L, 254R, as shown, are lines going from the center of the polar coordinate system through points 258L and 258R. Points 258L, 256R are located where curve 259 intersects a minus 3 dB circle 257. The conical angle 256 as shown in FIG. 10 is approximately 30 degrees.

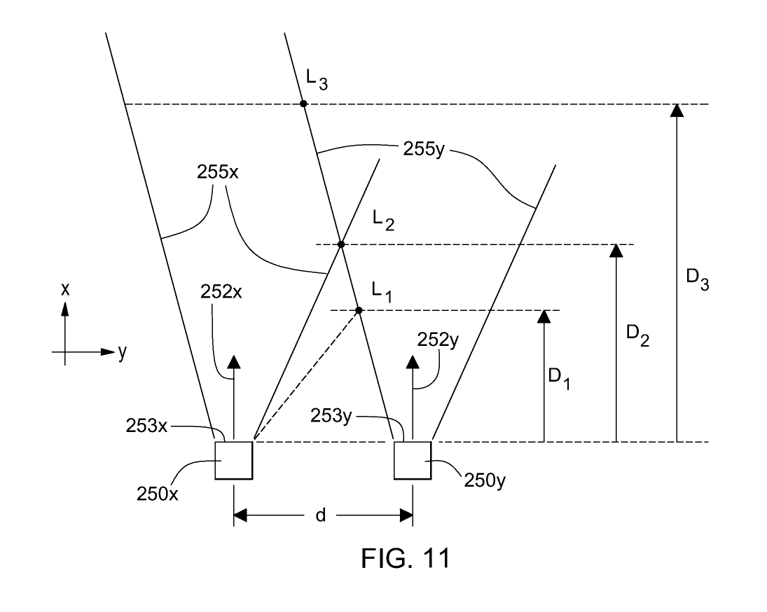

When two or more transducers 250 are arranged to cooperatively emit energy, such an arrangement is often called an array of transducers 250 or simply an array. One such array, having two transducers, is depicted in FIG. 11. In general, each transducer 250 of an array emits energy and such energy is combined to form an array energy profile. The energy from each transducer 250 is combined at a location thereby providing a combined energy density value at the location. The energy at any location and hence the shape of the array profile is determined by the emission characteristics of each transducer and other factors. Such other factors include, for example, the geometry of the array and the signal from the energy source that provides the excitation for each emitting transducer 250.

Examples, illustrating how energy from two transducers may be combined, are depicted in FIG. 11. Such examples indicate how a desired profile, such as exemplary profile 210 (FIGS. 6-8), for transmitter 100 (FIG. 1) may be created. A first emitting transducer 250x and second emitting transducer 250y, as depicted in FIG. 11, are separated by a distance, d. The emission axes 252x, 252y of the transducers 250x, 250y are parallel and the emission surfaces 253x, 253y of the transducers are in the same plane. Each transducer 250x, 250y emits ultrasonic energy at a respective transducer emission frequency fx or fy. For some arrays the frequencies fx and fy are equal and for other arrays the frequencies fx and fy are not equal. When the frequencies of emission for the transducers are not equal, then energy at a location, such as, for example L1, L2, or L3, is the sum of the energy from each transducer 250x, 250y.

For example, at a first location L1, ultrasonic energy is received from transducers 250x, 250y. Because location L1 is on the boundary 255y of transducer 250y, the energy received from transducer 250y is a negative 3 decibels. Additional energy at location L1 is received from transducer 250x. Because location L1 is outside of boundary 255x of transducer 250x, the energy available from transducer 250x is less than negative 3 decibels, for example, approximately negative 4 decibels. However, the combined ultrasonic energy density at location L1 is the sum of the energy density from each of transducers 250x, 250y. Hence the combined energy density is somewhat greater than negative 3 decibels and may be around minus one decibel as would be understood by those skilled in the art.

As a second example, consider the energy received at location L2. At location L2 equal amounts of energy are received from each of the transducers 250x, 250y. As depicted in FIG. 11, location 12 is on the boundary 255x of transducer 250x and on the boundary 255y of transducer 250y. When the two energy values of minus 3 decibels are combined, the combination provides an energy density at location L2 equal to approximately zero decibels. The energy density at location L3 is the sum of the energy density received from each of the transducers 250x, 250y. At location L3 the energy density is somewhat greater than zero decibels since location L3 is inside the boundary 255x of transducer 250x and on the boundary 255y of 250y.

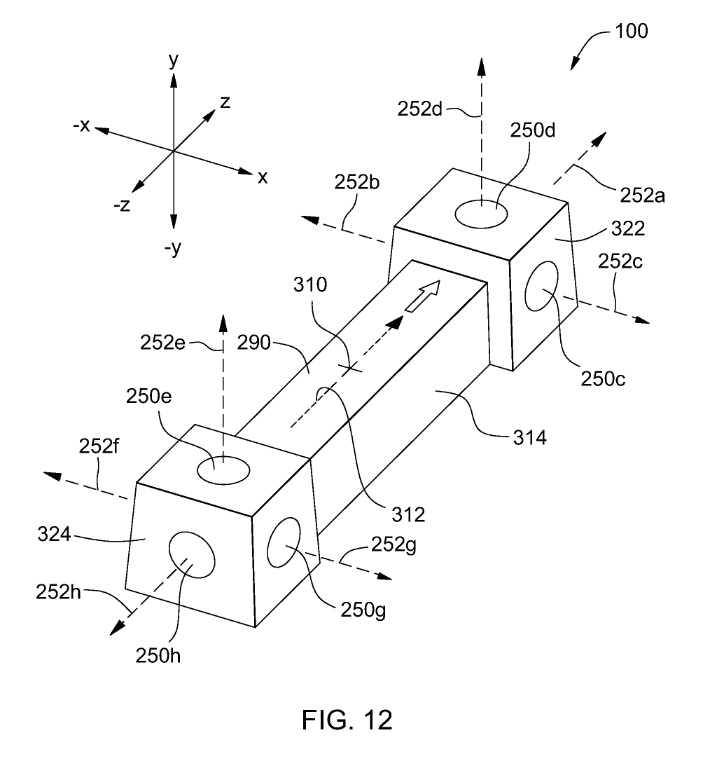

An exemplary transmitter 100 for providing profile 210 is depicted in FIG. 12. The transmitter 100 of FIG. 12 comprises a frame 290, eight transducers (250a-h), electrical circuits (not shown), and a power source (not shown). Frame 290 of the embodiment has a dumbbell shape where an arm 314 is connected between a front member 322 and a rear member 324. A reference point 310 is located on the top surface of arm 314. A reference axis 312 of transmitter 100 is a line passing through reference point 310 and parallel to the z direction as seen in FIG. 12.

Four transducers 250a-d are mounted in the front member 322. In addition, four transducers 250e-h are similarly mounted in the rear member 324. The transducers 250a-h receive excitation signals from electrical circuits. In one embodiment the electrical circuits are located within frame 290. However in other embodiments the electrical circuits may be placed in other locations.

The axes of emission 252a-h for the transducers 250a-h, respectively, as shown in FIG. 12, are positioned for emission in various directions. For example, axis of emission 252d of transducer 250d is positioned for emission in the y direction. In addition, axis of emission 252g of transducer 250g is positioned for emission in the x direction, and axis of emission 252h of transducer 250h is positioned for emission in the negative z direction. Because transducers 250a-h are placed at various locations on frame 290 and have axes of emission 252a-h pointed in various directions, the transmitter 100 as shown in FIG. 12 is capable of creating a variety of emission profiles. Different profiles can be generated by positioning transducers 250 at different respective positions, and/or using other numbers of transducers. Further, profile 210 may be modified by changing one or more of the excitation signals that supply energy to the transducers 250a-h as will be seen.

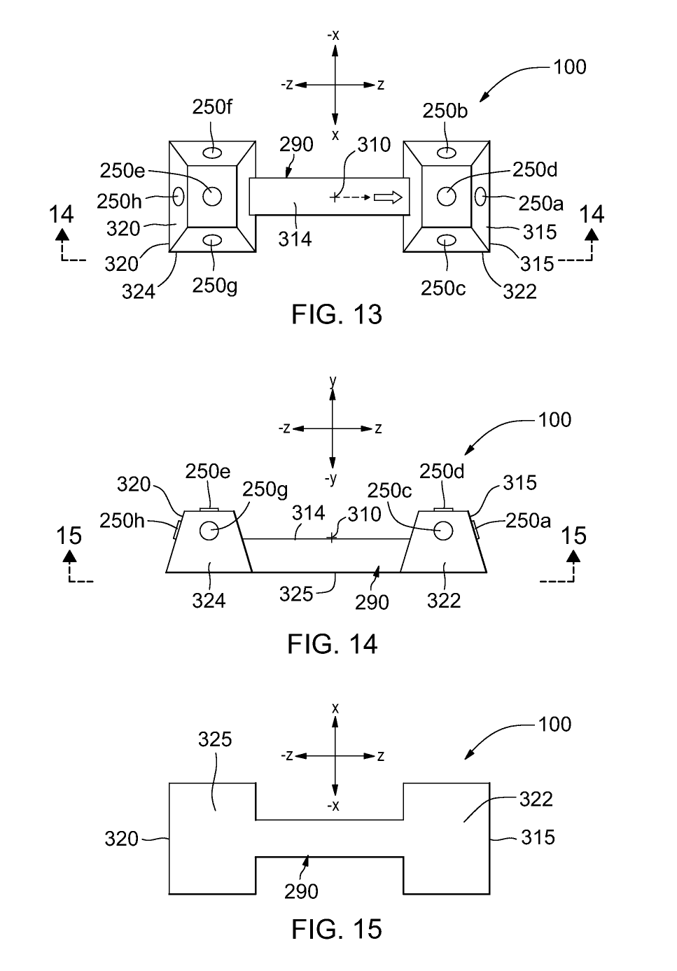

A top view of transmitter 100 is depicted in FIG. 13. The top view shows the location of each transducer 250a-h that is mounted in the front member 322 and rear member 324 of frame 290. Reference point 310 is shown on the top surface of arm 314. A side view of transmitter 100 is depicted in FIG. 14 and shows various details of the position of each transducer 250a-h on frame 290. A front surface 315 and rear surface 320 are also shown in FIG. 14. A bottom surface 325 of frame 290 is depicted in the side view and shown to be generally flat and parallel to the top surface of arm 314.

A bottom view of transmitter 100, depicted in FIG. 15, indicates there are no transducers 250 on the bottom surface 325 of frame 290. In one embodiment, the bottom member is removable for access to electrical circuits and a power source that are mounted within frame 290. In other embodiments other portions of frame 290 may provide access to electrical circuits and a power source.

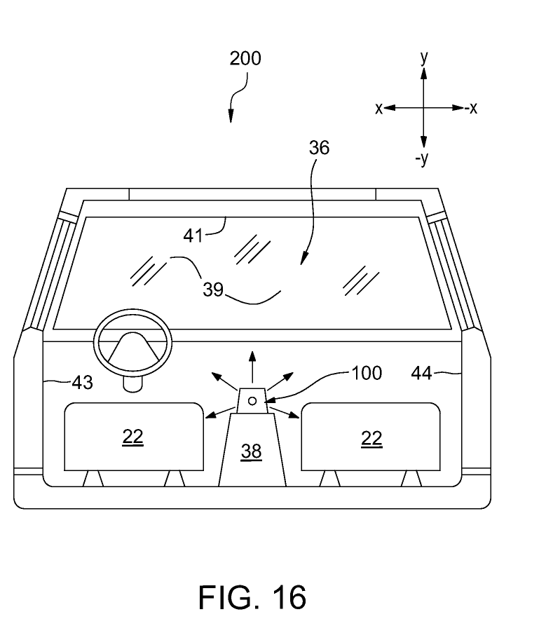

FIG. 16 depicts compartment 36 that shows transmitter 100 resting on console 38. As shown in FIG. 16, some of the emitted energy is directed towards the left side surface 43 and right side surface 44 in the compartment 36. However, as is depicted, some of the emitted energy travels through seat 22 before reaching bottom areas of side surfaces 43, 44. Other portions of the emitted energy are directed upward (the y direction) towards top surface 41. In other embodiments, the transmitter 100 may be placed at other locations in the compartment 36. In order for leak detection system 30 to obtain consistent results, transmitter 100 is placed and secured at a selected location within compartment 36 corresponding to the VIN for the vehicle 200. The transmitter 100 is positioned at and fastened to the selected location in compartment 36 by a variety of devices, such as, for example, alignment clamps, brackets, and sleeves. Other devices can be adapted for positioning and fastening the transmitter 100 to a selected location.

As a mere example, the transmitter 100 may have a mold (not shown) that has a cavity in the shape of a glove compartment or other type of compartment between the driver and front passenger seats. The cavity may be shaped such that walls of the cavity are flush with the glove compartment when the transmitter is appropriately positioned on the compartment. Thus, by ensuring that the transmitter 100 is positioned on the glove compartment such that the top of the glove compartment fits within the mold's cavity, a user ensures that the transmitter 100 is appropriately positioned. By doing the same with vehicles of the same model, a user ensures that the transmitter's position within each such vehicle is exactly the same helping to improve the accuracy of the tests. For example, a test may be performed to determine a profile of energy emitted from a leak-free vehicle while the transmitter 100 is at a position within such vehicle. Such profile may be compared to the profile of energy emitted from another vehicle to determine whether this other vehicle has a leak. If the transmitter 100 is at the same position within each respective vehicle for the two tests, then test results are likely to be more accurate.

In other embodiments, other techniques for ensuring that the transmitter 100 is at the same respective position within multiple vehicles being tested. For example, for each test, the transmitter 100 may be positioned such that a particular portion of the transmitter 100 contacts the same component (e.g., a seat belt fastener, an emergency brake handle, or a glove compartment) of the vehicle under test. Straps, clamps, or other types of devices may be used to secure the transmitter 100 to the vehicle component to ensure that the transmitter's position does not change during the test. Further, the vehicle components and cabs of different vehicles are often different. It may be desirable and sometimes necessary for the relative positioning of the transmitter 100 in a vehicle of one model to be different than that of another model. In fact, as described above, a user may position the transmitter 100 within the cab of a vehicle based on the vehicle model or the vehicle's VIN. Indeed, the desired positioning may vary from model-to-model depending on various factors, such as the acoustic characteristics of vehicle compartment of the model being tested.

Although the exemplary frame 290 has a dumbbell shape, the transmitter 100 may have a variety of other shapes in other embodiments. In general, a transmitter frame, such as exemplary frame 290, has multiple sites for mounting multiple transducers 250 so that the axis of emission 252 of each mounted transducer is pointed in a desired-direction. In addition, a frame, such as exemplary transmitter frame 290, has a cavity for holding electrical circuits, a power supply and other components of transmitter 100. In other embodiments of transmitters, there are other frames with other shapes that hold other numbers of transducers 250. The axes of emission 252 of the transducers in other embodiments can be directed to form profiles with other shapes.

In general, the shape of profile 210 of transmitter 100 depends on the location of transducers and the characteristics of each signal that provides excitation energy to each of the transducers 250. For the exemplary embodiment of transmitter 100 as shown in FIG. 12, the location of the transducers 250a-h is fixed. Hence, profile 210 has its shape controlled by controlling the excitation signal associated with each transducer 250a-h. The desired values of voltage, frequency, and phase of each excitation signal for various vehicle types is stored in memory so that profile 210 is tailored based on vehicle type. In general, the energy density emitted from transducer 250 is approximately proportional to the voltage of the excitation signal. Further, as would be understood by those in the art, the frequency and phase of the emitted signal corresponds to the frequency and phase of the excitation signal. In one embodiment, each transducer 250a-h emits a different frequency. In other embodiments, the frequency of each transducer 250 has any desired frequency. In other embodiments, the frequency emitted by each transducer 250 is the same and the voltage and phase have other desired values. Various other combinations of frequency, voltage, and phase are possible.

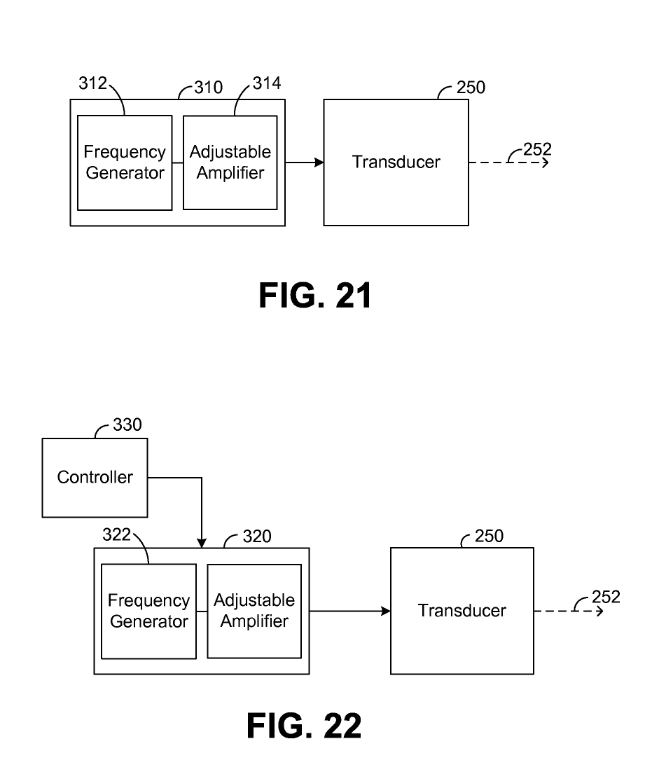

The energy emitted from transducer 250 may be expressed in decibels or as a percent of the maximum output power of the transducer. In one embodiment, each of the transducers 250a-h has approximately the same maximum output power and desired power levels are expressed as a percent of the maximum output power, which is the same for each of the transducers. In other embodiments, the maximum output power for at least one the transducers may be different than that for any of the others. Exemplary power level settings for one embodiment have transducer 250a set at 75%, transducers 250b and 250c set at 10%, transducers 250d and 250e set at 35%, transducers 250f and 250g set at 50%, and transducer 250h set at 100%. The output power from each of transducer 250a-h is approximately proportional to the voltage of an excitation signal. Such excitation signals are outputs from electrical circuits of the transmitter 100. In one embodiment electrical circuits are mounted within frame 290 of transmitter 100. Various details of embodiments of exemplary electrical circuits are described in FIG. 21 and FIG. 22.

A measurement chamber 400 for determining and viewing the shape of profile 210 for transmitter 100, such as shown in FIG. 12, is depicted in FIG. 17. In one test for determining the shape of profile 210, transmitter 100 has the power parameters set to the percentages described above. Transmitter 100 is placed on and secured to a conventional test fixture (not shown) in measurement chamber 400. The test fixture is located at a fixed distance from a test receiver 410.

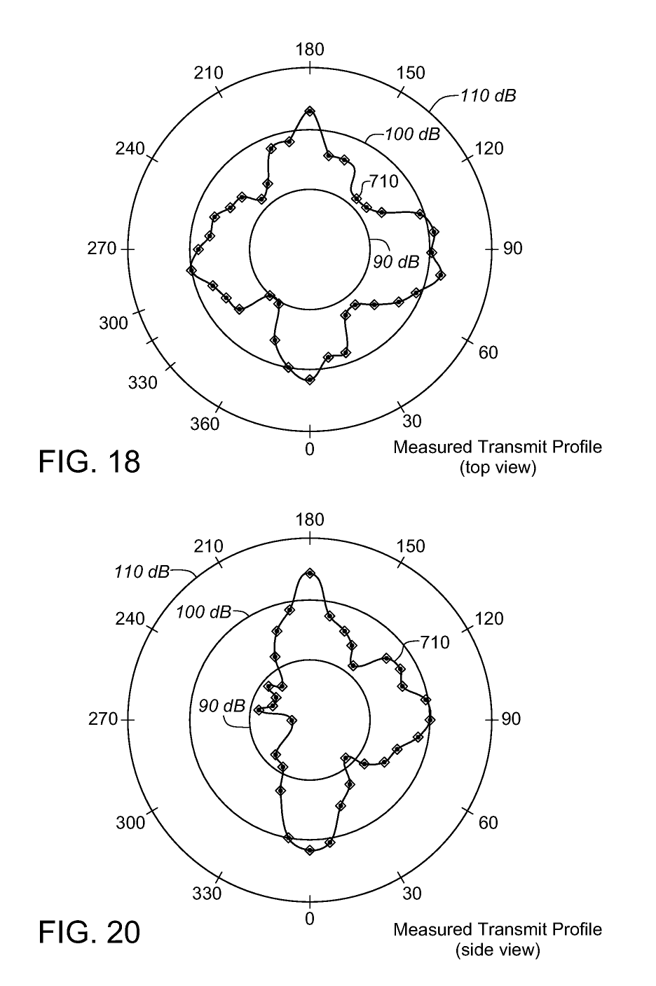

After the transmitter is secured to the test fixture, the measurement process begins when transmitter 100 is activated and emits ultrasonic energy. Test receiver 410 receives a portion of the ultrasonic energy emitted in the z direction. As transmitter 100 emits energy, the transmitter 100 is incrementally rotated, for example, in 5-degree increments, about a test axis. The test axis is essentially perpendicular to the x-z plane and passes through the reference point 310 of transmitter 100. Test receiver 410 receives and measures energy at each incremental angle value of rotation as the transmitter 100 rotates from zero to 360 degrees. A polar plot of measured energy versus angle of rotation, describes, in a two-dimensional view, the profile 210 of transmitter 100. An example of such a profile is depicted in FIG. 18. When transmitter 100, as depicted in FIG. 17, rotates as described above, the measured profile is similar to the top view profile 210 depicted in FIG. 6. Measured values of received energy, emitted from transmitter 100 and detected by test receiver 410, are recorded as a function of the rotational angle where the rotational angle has incremental values. The measured values and angle increments may be recorded either manually or by control and monitor unit 420 as would be understood by those skilled in the art.

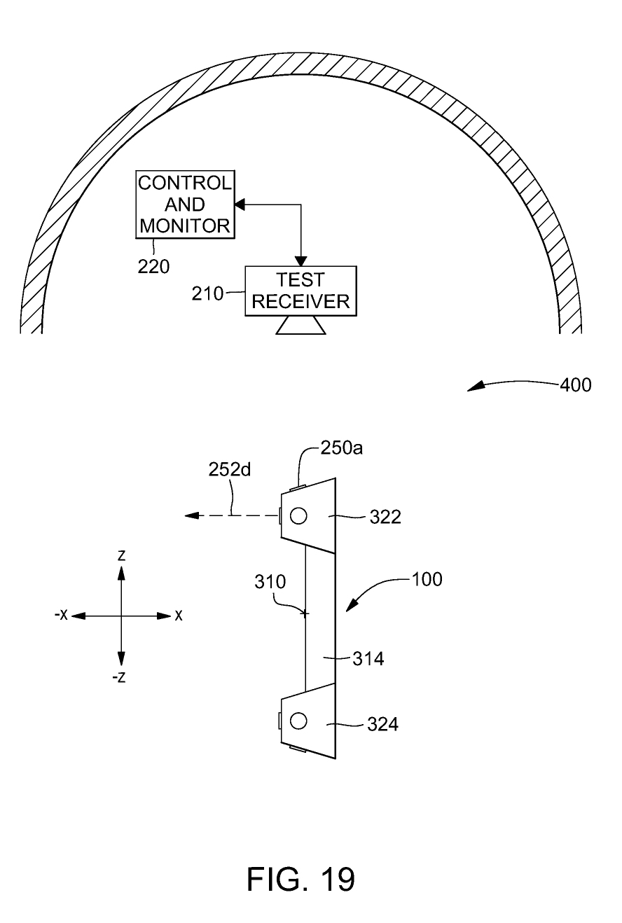

In order to create a measured side view of profile 210 for transmitter 100, the transmitter 100 is oriented as shown in FIG. 19. The profile created when the transmitter 100 is arranged as shown in FIG. 19 is similar to the side view profile shown in FIG. 8. Transmitter 100, as shown in FIG. 19, is placed on a test stand (not shown) for rotation about the test axis. The test axis extends through test point 310 of arm 314 when making measurements for the side view of profile 210. The new orientation of transmitter 100 is obtained by rotating the transmitter 90 degrees about reference axis 312 so that the top surface of arm 314 is perpendicular to the z-y plane so that axis of emission 252d of transducer 250d is essentially pointing in the minus x direction. After transmitter 100 is positioned in the new orientation, the transmitter 100 is activated and has the percentage of power value settings as previously described. Transmitter 100 is then incrementally rotated in on the test axis while energy is emitted from the transmitter. Test receiver 210 measures the energy as a function of angle in order to obtain vertical view of profile 210. The measured vertical view of profile 210 is shown in FIG. 20.

The transmitter 100 depicted in FIG. 12 is configured to provide a variety of profiles, such as exemplary profile 210, for detecting leaks in a variety of vehicles when incorporated as an element of the leak testing system 30 of FIG. 1. The frame 290 of transmitter 100 as depicted in FIG. 12 has fixed mounting locations for transducers 250 a-h, although other locations in other frames are possible. In that regard, when the location of transducers 250a-h is fixed as depicted, a profile is modified by varying the output energy emitted from each transducer 250a-h. Since the output of each transducer 250a-h is controlled by the excitation signal furnishing power to each of transducer 250a-h, the profile of transmitter 100 is modified by changing the excitation signals received from electrical circuits that are coupled to the transducers 250a-h. In that regard, the frequency, phase and voltage of the excitation signal determine respectively, the frequency, phase and power of the emitted ultrasonic energy. In one embodiment, the frequency of each excitation signal is the same and the voltage value is varied to control the power output of each of the transducers 250a-h. For other embodiments, the excitation signals have a variety of frequencies, phases and voltages.

In one embodiment, a power supply for furnishing energy to the electrical circuits is a battery. In other embodiments the power supply is one of other conventional sources. Because the power characteristics of a battery change as the battery discharges, a monitor circuit alerts the user when the battery reaches a threshold power level that results in undesirable performance. The threshold value is typically dependent on characteristics of electrical circuits and/or the characteristics of transducers 250a-h. In one embodiment, a notification signal is sent to test manager 50 when the battery condition is undesirable. Other embodiments for notification may have other devices that provide notification, such as for example, transmitter 100 has a notification element, such as a light emitting diode or an audio signal generating device.

The electrical drive circuits furnishing excitation signals to each transducer 250a-h may be adjusted manually or automatically. In an embodiment where the excitation circuits are adjusted manually, a panel is removed from the frame 290 of transmitter 100 for access to adjustable components of the adjustable drive circuits. In other embodiments, there may be other ways to access the adjustable components. When the panel is removed, the circuits are adjusted to values corresponding to a VIN in order to provide a profile for a particular vehicle.

FIG. 21 depicts an adjustable drive circuit 310 that provides an excitation signal to transducer 250. In general, the drive circuit 310 comprises of a frequency generator 312 and an adjustable amplifier 314 having an adjustable gain. The frequency generator 312 can be a conventional tunable frequency generator that is sometimes referred to as a tunable oscillator. The frequency generator 312 has a component for adjusting the output frequency of the generator, such as, for example, an adjustable variable capacitor. The frequency output of generator 312 is adjusted so that the output frequency of the ultrasonic energy from transducer 250 has a desired value. In one embodiment, the frequencies from the frequency generator are generally limited to a range of frequencies between approximately 38 and 42 kHz, although other frequencies may be used in other embodiments. The output of the frequency generator 312 is coupled to the adjustable amplifier 314. The adjustable amplifier 314 can be a conventional adjustable gain amplifier having a range of adjustable gains. For transmitter 100, the range of gains of the adjustable amplifier 314 is dependent of the desired range of output powers for the transducer 250. For one embodiment, the gains of amplifier 314 provide excitation signals that cause the output power of the transducer 250 to vary between around zero and 100 percent of maximum power. For other embodiments, the adjustable amplifier 314 has a range of gains for other ranges of power values for transducer 250. In one embodiment of transmitter 100, adjustable drive circuit 310 is a dedicated to furnishing an excitation signal to one transducer 250. For exemplary transmitter 100 of FIG. 12, each transducer 250a-h receives an excitation signal from a respective drive circuit 310a-h. For other embodiments, adjustable drive circuit 310 furnishes an excitation signal to one or more transducers 250.

In an embodiment where the electrical drive circuits are automatically adjusted, parameter information is transferred from test manager 50 to transmitter 100 via a communication link. A typical communication link is described in previously referenced U.S. Utility patent application Ser. No. 11/586,418 entitled, “System and Method for Controlling Emission of Acoustic Energy for Detecting Leaks in Vehicles” filed on Oct. 25, 2006. In other embodiments, information is stored at other locations, such as, for example, in a memory component of transmitter 100. Parameters of a programmable electrical drive circuit 320 as shown in FIG. 22 are automatically adjusted to values corresponding to a vehicle identifier, such as a VIN.

FIG. 22 depicts an exemplary programmable drive circuit 320 that supplies an excitation signal to transducer 250. In general, the drive circuit 320 is comprised of a programmable frequency generator 322 and a programmable amplifier 324, such as a programmable log amplifier. The programmable frequency generator 322 can be a conventional programmable frequency generator that is sometimes referred to as an adjustable digital oscillator. The programmable frequency generator 322 has parameters that are adjusted in response to values from a control unit 330. The parameter values transferred from the control unit 330 to the programmable frequency generator 322 are set to provide an output signal with a desired frequency. The frequency of the signal from the programmable frequency generator 322 is selected to meet the desired frequency characteristics of the transducer 250. The selected frequency is generally limited to a range of frequencies, such as, for example, frequencies between approximately 38 and 42 kHz. The output of the programmable frequency generator is coupled to the programmable amplifier 324. The programmable amplifier 324 can be a conventional programmable amplifier having a range of gains. The range of gains of the programmable amplifier is chosen to provide the desired range of output power of transducer 250. For one embodiment of a transmitter, having one or more transducers, the frequencies of the signal from each programmable frequency generator are the same. In other embodiments, the frequencies of the signals from the programmable frequency generators 322 have a variety of ranges. In general, programmable circuits 320 have parameter values that provide for adjustment of power, frequency and phase. In one embodiment, where the frequency of each programmable frequency generator 322 is the same, the phase of the signal from the generator is varied so as to provide constructive and/or destructive interference of the transmitted ultrasonic energy as would be understood by those skilled in the art.

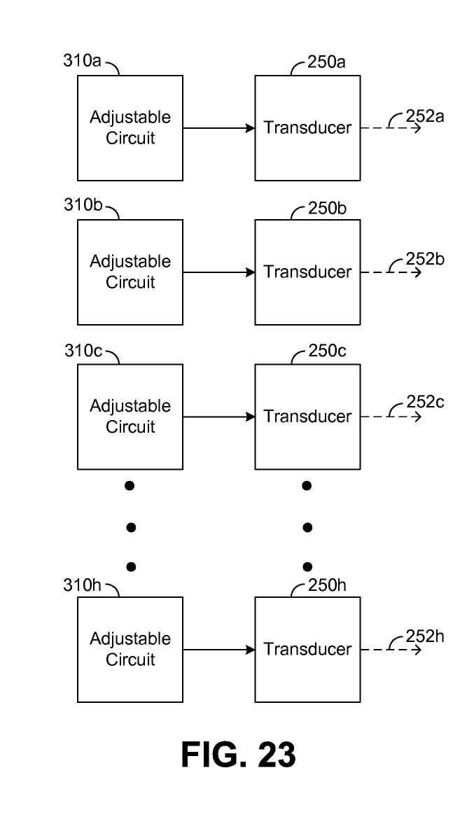

In one exemplary embodiment of transmitter 100, such as shown in FIG. 12, multiple adjustable electrical circuits 310a-h, depicted in FIG. 23, furnish excitation signals to each of eight transducers 250a-h. Other numbers of transducers 250 in other embodiments are possible. Each adjustable circuit 310a-h is coupled to a respective transducer 250a-h. In one embodiment, each adjustable circuit 310a-h has independently adjustable parameters. When the parameters are independently adjustable each transducer 250a-h has an independent control for frequency and ultrasonic power output. In other embodiments, an adjustable circuit 310 furnishes an excitation signal to more than one of the transducers 250a-h.

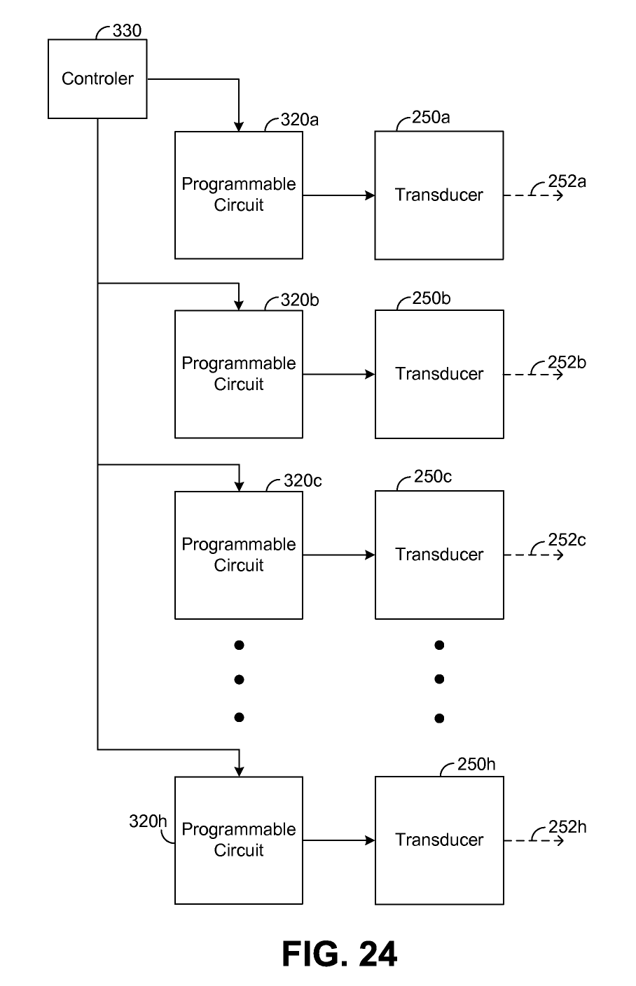

An exemplary circuit for automatically adjusting the output of the transducers 250a-h comprises multiple programmable circuits 320a-h that are respectively coupled to the transducers, as depicted in FIG. 24. Each programmable circuit 320a-h receives commands and information from controller 330 as previously described. In one embodiment, each programmable circuit 320a-h has parameters that are adjusted for controlling respectively at least one parameter of each transducer 250a-h. The circuit parameters of programmable circuits 320a-h include at least frequency, phase and gain. Such circuit parameters of programmable circuits 320a-h respectively determine the frequency, phase and power emitted from each of transducers 250a-h. The range of the amplifier gains is variable and in one embodiment has a decibel range of around 40 decibels. In other embodiments other ranges of amplifier gain are possible. In general, programmable circuits 320 have parameter values that provide for control of power, frequency and phase emitted ultrasonic energy emitted form a transducer. In one embodiment, where the frequency of each programmable frequency generator 322 is the same, the phase of the signal from the generator is varied so as to provide constructive and/or destructive interference of the transmitted ultrasonic energy as would be understood by those skilled in the art.

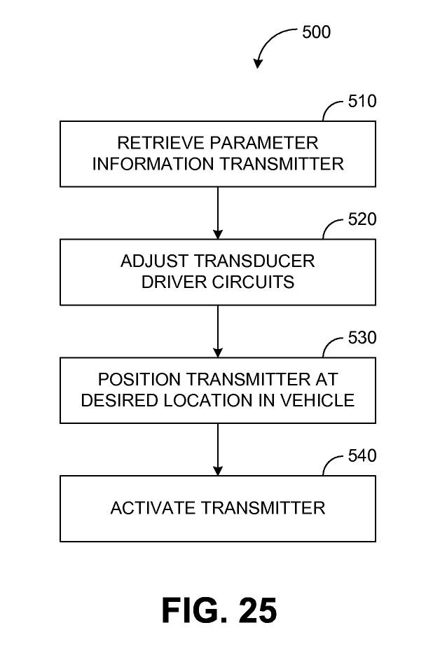

An exemplary method embodiment, shown as flow chart 500, is depicted in FIG. 25. In order to provide a desired profile, parameter information is retrieved, step 510. In general, the retrieved information is associated with a VIN and is stored in memory at in a component, such as, for example, the test manager 50, of system 30. Next, step 520, parameters of electrical circuits 220 are adjusted to values contained in the retrieved information. Next, transmitter 400 is placed at a desired location within cavity 36 of vehicle 200, step 530. Transmitter 100 is then activated, step 540, and then vehicle 200 moves through the array of sensors 45 of leak detection system 30.

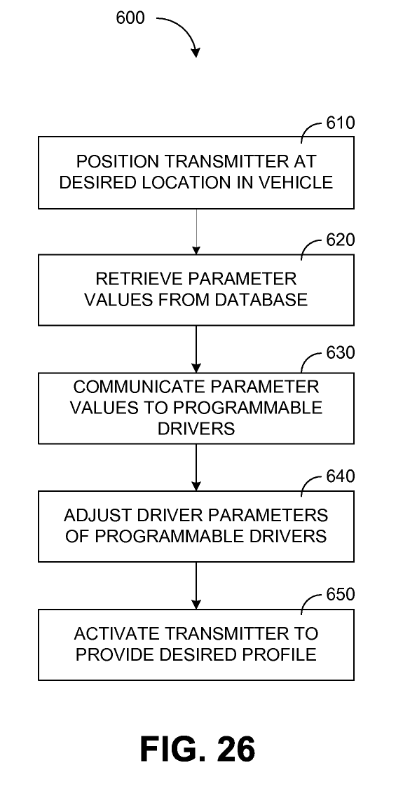

Another exemplary method embodiment is depicted by the flow chart 600 of FIG. 26. The first step 610, is placing transmitter 100 at a desired location within compartment 36. Next parameter values are retrieved, step 620, from a memory in test manager 50. The values of the retrieved parameters are then sent to the transmitter 100, step 630, via the communication link of leak detection system 30. The driver circuit parameters are then automatically set, step 640, for programmable circuits 320 of transmitter 100. The transmitter 100 is then activated, step 650, upon receiving a control signal from the test manager 50.

1. A system for detecting leaks in sealed compartments, comprising:
at least one sensor for sensing acoustic energy emitted from a sealed compartment under test;
a test manager configured to detect a leak in the sealed compartment based on the at least one sensor; and
an acoustic transmitter positioned within the sealed compartment, the transmitter having a plurality of transducers and at least one amplifier for providing excitation power for the plurality of transducers wherein the at least one amplifier is adjustable.

2. The transmitter of claim 1, wherein the excitation power is adjusted to provide a desired emission profile.

3. The transmitter of claim 2, wherein the desired emission profile is based on a vehicle identification number.

4. The transmitter of claim 2, wherein the at least one amplifier is adjusted manually.

5. The transmitter of claim 2, wherein the at least one amplifier is adjusted by a controller that provides a control signal over a communication link.

6. The transmitter of claim 1, wherein the plurality of transducers coat the interior surfaces of the sealed compartment with substantially equal amounts of ultrasonic energy.

7. The transmitter of claim 6, wherein the sealed compartment is a compartment of a vehicle.

8. The transmitter of claim 1, wherein the plurality of transducers are positioned such that one of the transducers directs acoustic energy toward one side of the sealed compartment and another of the transducers directs acoustic energy toward another side of the sealed compartment.

9. A method for detecting leaks in sealed compartments, comprising the steps of:
placing a transmitter with a plurality of transducers within a sealed compartment;
determining a power level output for each of the transducers in order to provide a desired energy profile;
adjusting the power level output for each of the transducers based on the determining step;
sensing energy from the transducers external to the sealed compartment; and
detecting a leak in the sealed compartment based on the sensing step.

10. The method of claim 9, wherein the determining step comprises retrieving a power level setting that corresponds to an identifier for the compartment.

11. The method of claim 10, wherein the adjusting step comprises the step of manually setting the output power level of at least one of the transducers.

12. The method of claim 10, wherein the adjusting step comprises the step of sending a wireless control signal to at least one adjustable amplifier that is coupled to at least one of the transducers.

13. The method of claim 10, wherein the determining step comprises the step of retrieving transducer output values corresponding to a vehicle identification number.

14. The method of claim 10, further comprising the steps of:
placing the transmitter within another sealed compartment; and
ensuring that the transmitter is positioned at the same relative position within each of the sealed compartments via the placing steps.
